(19) United States
(12) Patent Application Publication
(10) Pub. No.: US 2016/0291844 A1
(43) Pub. Date: Oct. 6, 2016

(54) METHOD AND APPARATUS FOR OPENING A DATA PROCESSING PAGE

(71) Applicant: Tencent Technology (Shenzhen) Co., Ltd., Shenzhen (CN)

(72) Inventor: Zhonghua LAI, Shenzhen (CN)

(21) Appl. No.: 15/182,089

(22) Filed: Jun. 14, 2016

Related U.S. Application Data
(63) Continuation of application No. PCT/CN2014/095927, filed on Dec. 31, 2014.

(30) Foreign Application Priority Data
Dec. 31, 2013 (CN) 2013107544933

(51) Int. Cl. G06F 3/0484; G06F 3/0482

(52) U.S. Cl. CPC G06F 3/04842; G06F 3/0482

(57) ABSTRACT

The present disclosure discloses a method and an apparatus for opening a data processing page. The method includes: opening a function information page which is set up by a current application, displaying presentation information of a plurality of a plurality of function objects in the function information page, and displaying at least one page link button corresponding to at least one of the plurality of function objects; when a click instruction corresponding to a target page link button in the page link button is received, opening a data processing page of a function object corresponding to the target page link button; and when a resource transfer instruction corresponding to the function object is received, performing processing of account binding on an account of the current application and a resource library account.

### CROSS-REFERENCE TO RELATED APPLICATIONS

The application is a continuation of PCT Application No. PCT/CN2014/095927, filed on Dec. 31, 2014, which claims priority to Chinese Patent Application No. 2013107544933, filed on Dec. 31, 2013, which is incorporated by reference in their entireties.

### FIELD OF THE TECHNOLOGY

The present disclosure relates to the field of Internet technologies, and in particular to a method and an apparatus for opening a data processing page.

### BACKGROUND

Development in high speed Internet and computer technologies have brought new application tools to improve our daily life and work life. An important aspect in the development of Internet is to provide a resource transfer function (a function of transferring a resource from a resource library account to another resource library account, such as a payment function) to a terminal, and for a network service provider to keep up with the pace of adding the resource transfer function into various applications.

Conventional technology may involve an application setting up a resource transfer function in a function information page. Presentation information of multiple function objects (namely, multiple resource transfer functions, such as, triggering and starting of music and video play through resource transfer) may be displayed on the function information page, which the presentation information may be relevant introduction information of a certain resource transfer function. An account binding button may generally be further set in the function information page. After clicking the account binding button, a user may bind an application account with a resource library account (such as a value account). Upon the binding, the user may enter a function selection page. A function object (resource transfer function) list may be displayed in the function selection page, and the user may then select the resource transfer function which the user intends to use in the function selection page, and enter a data processing page (such as a music play page) of the resource transfer function in order to perform a subsequent resource transfer process.

### SUMMARY

Embodiments of the present disclosure provide a method and an apparatus for opening a data processing page which improve an efficiency of entering a data processing page.

An embodiment of the disclosure discloses a method for opening a data processing page is provided, the method may include: opening a function information page which is set up by a current application, displaying presentation information of a plurality of a plurality of function objects in the function information page, and displaying at least one page link button corresponding to at least one of the plurality of function objects; when a click instruction corresponding to a target page link button in the page link button is received, opening a data processing page of a function object corresponding to the target page link button; and when a resource transfer instruction corresponding to the function object is received, performing processing of account binding on an account of the current application and a resource library account.

Another embodiment discloses an apparatus for opening a data processing page is provided, the apparatus may include: at least a processor with circuitry operating in conjunction with a memory storing codes to be executed as a plurality of modules, wherein the plurality of modules may include: a displaying module, which causes the processor circuitry to perform: opening a function information page which is set up by a current application, displaying presentation information of a plurality of function objects in the function information page, and displaying at least one page link button corresponding to at least one of the plurality of function objects; an opening module, which causes the processor circuitry to perform, when a click instruction corresponding to a target page link button in the page link button is received, opening a data processing page of a function object corresponding to the target page link button; and a binding module, which causes the processor circuitry to perform, when a resource transfer instruction corresponding to the function object is received, performing processing of account binding on an account of the current application and a resource library account.

Another embodiment discloses a non-transitory computer-readable storage medium, wherein the computer readable storage medium stores a program which comprises codes or instructions to cause a processor circuitry to execute operations for opening a data processing page, the operations include: opening a function information page which is set up by a current application, displaying presentation information of a plurality of a plurality of function objects in the function information page, and displaying at least one page link button corresponding to at least one of the plurality of function objects; when a click instruction corresponding to a target page link button in the page link button is received, opening a data processing page of a function object corresponding to the target page link button; and when a resource transfer instruction corresponding to the function object is received, performing processing of account binding on an account of the current application and a resource library account.

The advantages of performing the operations described in the method and performing by the apparatus may include: a user may directly skip to the data processing page by clicking a target page link button to obtain information in the data processing page to perform a subsequent resource transfer, thus skipping the step of returning to the binding process and then re-entering the data processing page, thereby improving the efficiency of completing a resource transfer.

### BRIEF DESCRIPTION OF THE DRAWINGS

The accompanying drawings may be included to provide further understanding of the claims and disclosure which may be incorporated in, and constitute a part of this specification. The detailed description and illustrated embodiments described may serve to explain the principles defined by the claims.

FIG. 1 is a flowchart of an exemplary method for opening a data processing page, according to an embodiment of the present disclosure.

FIG. 2 is an exemplary display of a terminal interface, according to an embodiment of the present disclosure.

FIG. 3 is another exemplary display of a terminal interface, according to an embodiment of the present disclosure.

FIG. 4 is an exemplary schematic structural diagram of an apparatus for opening a data processing page, according to an embodiment of the present disclosure.

FIG. 5 is an exemplary schematic structural diagram of a terminal for opening a data processing page, according to an embodiment of the present disclosure.

### DETAILED DESCRIPTION

The various embodiments of the present disclosure may be further described in details in combination with attached drawings and embodiments below. It should be understood that the specific embodiments described here may be used only to explain the present disclosure, and may be not which is used to limit the present disclosure. In addition, for the sake of keeping description brief and concise, the newly added features, or features that may be different from those previously described in each new embodiment will be described in details. Similar features may be referenced back to the prior descriptions in a prior numbered drawing or referenced ahead to a higher numbered drawing. Unless otherwise specified, all technical and scientific terms herein may have the same meanings as understood by a person skilled in the art.

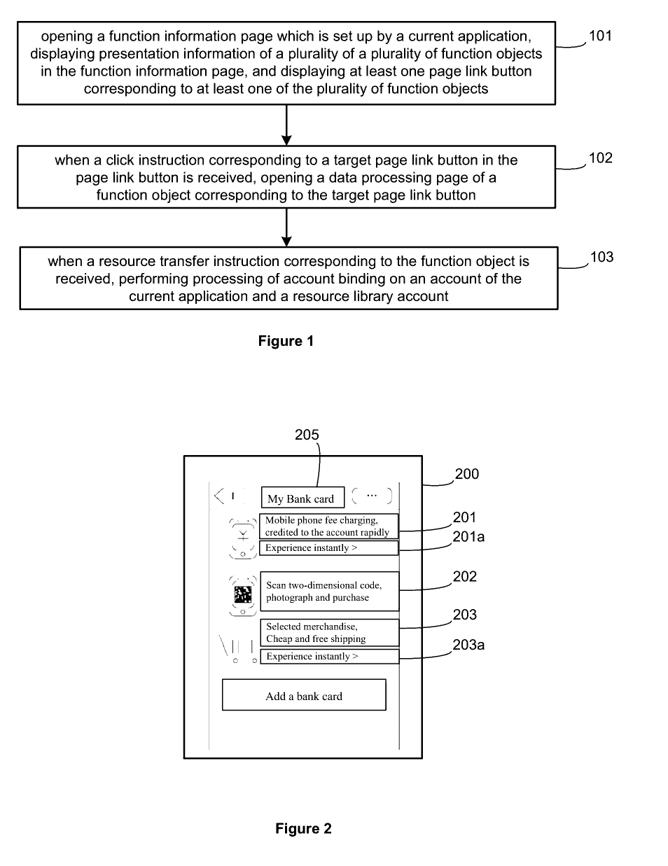

FIG. 1 is a flowchart of an exemplary method for opening a data processing page, according to an embodiment of the present disclosure. The method may include at least the following exemplary operations:

### Embodiment 1

Step 101: opening a function information page which is set up by a current application, displaying presentation information of a plurality of a plurality of function objects in the function information page, and displaying at least one page link button corresponding to at least one of the plurality of function objects.

Step 102: when a click instruction corresponding to a target page link button in the page link button is received, opening a data processing page of a function object corresponding to the target page link button.

Step 103: when a resource transfer instruction corresponding to the function object is received, performing processing of account binding on an account of the current application and a resource library account.

In the above embodiment, a function information page may be opened and presentation information of a plurality of function objects may be displayed in the function information page, and a page link button corresponding to at least one of the function objects may be displayed. When a click instruction corresponding to a target page link button in the page link button is received, a data processing page of a function object corresponding to the target page link button may be opened, in order that a user may directly skip to the data processing page by clicking the page link button in the function information page and obtain information in the data processing page, thereby improving efficiency of entering the data processing page.

### Embodiment 2

In another embodiment of the present disclosure, the described steps or operations may be performed by any terminal, preferably a mobile terminal such as a smart mobile phone or a tablet computer.

The processing by the terminal may take place as follows:

Step 101: a terminal may open a function information page which is set up by a current application, display presentation information of a plurality of function objects in the function information page, and display a page link button corresponding to at least one of the function objects.

The function information page may be a page which causes the processor circuitry to perform presenting and introducing a resource transfer function in an application. The resource transfer function may be a function for transferring a resource from a resource library account to another resource library account, and the resource in the embodiment of the present disclosure may be a value.

For example, the resource transfer function may be a value transfer function. The resource library account may be an account for recording a state of a resource possessed by a certain user, such as a material state account or a value account. The function object may be a function provided by an application, such as the resource transfer function. The presentation information may be information about introduction of the function object which causes the processor circuitry to perform presentation. The presentation information (200) may be information about an icon of the function object, a name of the function object, or a feature introduction of the function object. The page link button (201a or 203a) may be a button which causes the processor circuitry to perform triggering opening of a data processing page of a function object (201 or 203), such as an “experience instantly” button (201a or 203a) as shown in FIG. 2.

During implementation of the embodiment 2, a button for triggering opening of a function information page in a certain page of a certain application may be set. For example, in a certain page of a certain instant messaging application, a list of multiple auxiliary functions may be set which may include “my photo album”, “my favorite” and “my value transfer” as function objects. If the function object “my value transfer” may be clicked, the function information page may be opened and triggered. For an application account which is not bound with a resource library account, the function information page may be considered as a main page of a resource transfer function in the application.

In the function information page, presentation information of multiple resource transfer functions may be displayed. The presentation information (200) may include: an icon of the function object (201, 202 or 203), a name of the function object, and a feature introduction of the function object. For multiple function objects (201, 202, 203) in order to display whose presentation information, page link buttons (201a or 203a) corresponding to each of the multiple function objects (201 or 203) may be displayed. The displaying location of the page link button (e.g., 201a) corresponding to a respective function object (e.g., 201) may be set close to presentation information of the function object, for example, setting below the function object (e.g., “my value transfer”) in the presentation information.

For the processing of step 101 (opening a function information page which is set up by a current application, displaying presentation information of a plurality of a plurality of function objects in the function information page, and displaying at least one page link button corresponding to at least one of the plurality of function objects), page link buttons 9201a or 203a) may be set for all function objects (e.g., 201, 203) whose presentation information may be listed in the function information page (200). In this regard, the user may be able to rapidly enter data processing pages of more function objects, and rapidly learn the information in the data processing pages.

Generally, an application may support multiple resource transfer functions. A certain rule may be set for selecting a part of the resource transfer functions, and presenting them in a function information page. The processing of displaying presentation information of a function object in step 101 may include at least the following operation (as steps 1 and 2):

Step 1: selecting a to-be-displayed function object from the plurality of a plurality of function objects supported by the current application according to a preset presentation algorithm.

The presentation algorithm may be an algorithm for selecting a function object for presentation from the plurality of function objects supported by the application, and may be any preset selection algorithm according to an actual demand, such as a random selection algorithm, a sequential selection algorithm, or a conditional selection algorithm. The current application is an application to which the foregoing function information page belongs. The function object supported by the current application is a resource transfer function which may be provided in the current application. The to-be-displayed function object is a function object whose presentation information prepares to be displayed in the function information page.

Specifically, the presentation algorithm may be randomly set according to an actual demand. For example, the presentation algorithm may select a to-be-displayed function object based on usage of different resource transfer functions (i.e., use frequency in a period of time), and correspondingly, the processing of step 1 may be: selecting a preset number of a plurality of function objects with the highest usage from the function objects supported by the current application as to-be-displayed function objects.

The preset number may be randomly set according to a demand, such as 3, 4 or 5.

During implementation of the embodiment 2, a terminal may query usage of each resource transfer function supported by the application from a background server of the application, and select several resource transfer functions with the highest usage as to-be-displayed resource transfer functions.

Additionally and specifically, the presentation algorithm may further select a to-be-displayed function object in combination with the current geographic location of the terminal, and correspondingly, the processing of step 1 may be: obtaining current geographic location information; and selecting the to-be-displayed function object from the plurality of function objects supported by the current application according to the preset presentation algorithm and the geographic location information.

During implementation of the embodiment 2, the terminal may also obtain its own current geographic location information from a positioning system, such current geographic location information may be an administrative region (such as Guangzhou, or Shenzhen) of a preset rank (province, city, county and so on) to which the terminal may currently belong. Querying of usage of each resource transfer function supported by the application in the administrative region from the background server of the application may be performed, and several resource transfer functions with the highest usage as to-be-displayed resource transfer functions may be selected.

Step 2: displaying presentation information of the selected function objects in the function information page.

During implementation of the embodiment 2, presentation information of all the resource transfer functions may be displayed according to an arrangement in a sequence, such as from top to bottom. Specifically, presentation information of all the resource transfer functions may be arranged according to a designated sequence, and correspondingly, the processing of step 2 may be as follows: displaying the presentation information of the selected function objects in the function information page according to a usage order.

In another implementation of the embodiment 2, the terminal may query usage of each to-be-displayed resource transfer function from the background server of the application, or, obtain usage of each resource transfer function stored locally after the previous querying, display presentation information of a resource transfer function with the highest usage uppermost, and arrange presentation information of all the resource transfer functions downward sequentially in a descending sequence of usage.

Step 102: when a click instruction corresponding to a target page link button (201a) in the page link button is received, opening a data processing page of a function object (201) corresponding to the target page link button (201a).

The target page link button may be any one of the page link buttons displayed in the foregoing function information page. The data processing page may be an execution page of a function object. From the viewpoint of the page form, the data processing page may be a data processing page in a current application, a webpage data processing page or a data processing page in a third party application.

During implementation of the embodiment 2, the terminal may open the function information page (200). After the presentation information and the page link buttons (201a, 203a) of multiple resource transfer functions (201, 203) are displayed in the function information page (200), the user may select a resource transfer function according to a demand of the user, and click a page link button (target page link button) of the resource transfer function. After clicking, the terminal may open and display the data processing page of the resource transfer function.

Step 103: when a resource transfer instruction corresponding to the function object is received, performing processing of account binding on an account of the current application and a resource library account.

The resource transfer instruction may include a value transfer instruction. The resource library account may include a value account.

During implementation of the embodiment 2 in the foregoing data processing page, a resource transfer confirming page may be entered after a corresponding operation. After the user checks the resource transfer confirming page to find that the corresponding resource transfer information (such as a transfer value) is correct, the user may click a determining key, which a generation of a resource transfer instruction may be triggered. If the current application account is not bound with a resource library account (such as a value account), opening of a page bound with a resource library account may be triggered so as to perform an operation process of binding a resource library account. The user may then input in an account input field, a resource library account which needs to be bound with the current application account. After the resource library account is successfully bound, resource transfer processing may be performed to transfer resource transfer (such as value transfer) from the bound resource library account to a certain designated resource library account.

Accordingly, the processing of binding a resource library account may be transferred from the time before entering a data processing page to the time after entering a data processing page so that the user may rapidly enter a data processing page, thereby improving the efficiency for the user to obtain relevant information of a function object.

In the embodiment 2 of the present disclosure, a user may directly skip to the data processing page by clicking the page link button in the function information page, and obtain information in the data processing page, thereby improving efficiency of entering the data processing page.

### Embodiment 3

A processing process of a method for opening a data processing page in the opening of the function information page, the displaying presentation information of a plurality of function objects in the function information page, and the displaying the at least one page link button corresponding to the at least one of the function objects, may include:

Step 101: open a function information page (200) (as shown in FIG. 2), and displaying the presentation information of the plurality of a plurality of function objects (201, 202, 203) in the function information page, and displaying the at least one page link button (e.g., 201a) corresponding to each of the plurality of function objects (e.g., 201).

In this embodiment 3, the function object may be a payment function, such as a mobile phone fee charging function (201), or a cinema ticket purchase function. The function information page may be a page with a function object “my bank card” (205) (as shown in the display interface in FIG. 2). The presentation information (200) may include information about the icons of a plurality of function objects, such as an icon shown in FIG. 2, the name of the function objects, such as “mobile phone fee charging” (201), “scanning two-dimensional code” (202), or “selected merchandise” (203) as shown in FIG. 2, or the feature introduction of the function object. The page link button such as an “experience instantly” button as shown in FIG. 2 (201a or 203a) may be a button which causes the processor circuitry to perform triggering opening of a transaction page of a payment function.

During implementation of the embodiment 3, the processing of determining a to-be-displayed function object, reference may be made to relevant content in step 101 in the Embodiment 2.

Step 102: when a click instruction corresponding to a target page link button in the page link button is received, opening a data processing page of a function object corresponding to the target page link button.

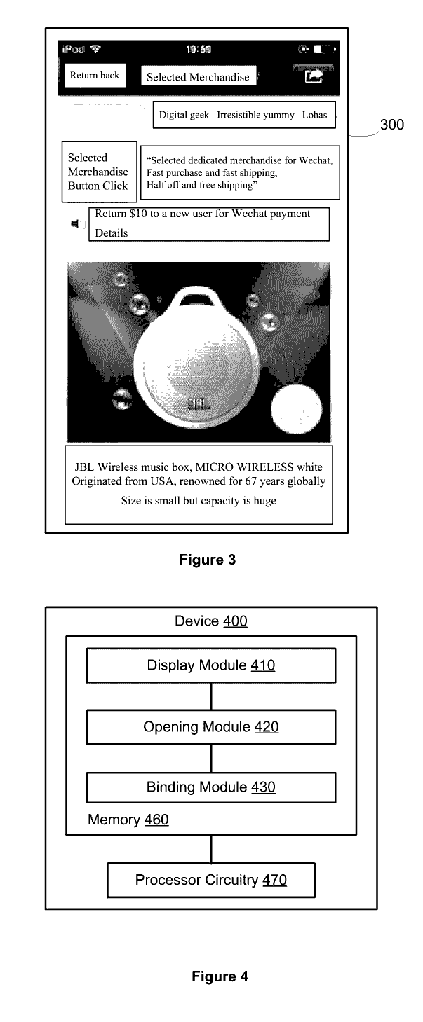

In this embodiment, the data processing page may be a payment function execution page, such as, a mobile phone fee charging page, a network shopping page (as shown in FIG. 3), or a credit card repayment page.

For example, as shown in FIG. 3, as long as a user clicks an “experience instantly” button (203a) of the “selected merchandise” payment function (203), the user may trigger an opening of the “selected merchandise” transaction page, namely, the network shopping page, the transaction page may be a webpage transaction page, and the user may select a merchandise to be transacted in the transaction page.

Step 103: when a resource transfer instruction corresponding to the function object is received, performing processing of account binding on an account of the current application and a resource library account.

In this embodiment, the resource transfer instruction may be a payment confirming instruction, and the resource library account may be a bank account.

For example, as long as the user inputs the charging amount in the data processing page for mobile phone fee charging, the user may click to confirm entering payment confirming page. After checking the displayed payment related information (such as the payment amount) in the payment confirming page, the user may click a determining key, a generation of the payment confirming instruction may be triggered.

If the current application account is not bound with a bank account, opening of a page bound with a bank account may be triggered so as to perform an operation process of binding a bank account, and the user may input, in an account input field therein, a bank card number needing to be bound. After the bank account is bound successful, resource transfer processing may be performed, and account transfer may take place from the bound bank account to a certain designated bank account.

In the above embodiment 3 of the present disclosure, a user may directly skip to the data processing page by clicking the page link button in the function information page, and obtain information in the data processing page, thereby improving efficiency of entering the data processing page.

### Embodiment 4

In an aspect of the embodiment, FIG. 4 discloses an apparatus (400) for opening a data processing page. The apparatus includes at least a processor (470) with circuitry operating in conjunction with a memory (460) storing codes to be executed as a plurality of modules, wherein the plurality of modules may include: a displaying module (410), an opening module (420) and a binding module (430).

The displaying module (410) may cause the processor (470) circuitry to perform: opening a function information page which may be set up by a current application, displaying presentation information of a plurality of function objects in the function information page, and displaying at least one page link button corresponding to at least one of the plurality of function objects.

The opening module (420) may cause the processor (470) circuitry to perform, when a click instruction corresponding to a target page link button in the page link button is received, opening a data processing page of a function object corresponding to the target page link button; and

The binding module (430) may cause the processor circuitry (470) to perform, when a resource transfer instruction corresponding to the function object is received, performing processing of account binding on an account of the current application and a resource library account.

In addition, the displaying module (410) may be used for: selecting a to-be-displayed function object from the plurality of function objects supported by a current application according to a preset presentation algorithm; and displaying presentation information of the selected function objects in the function information page.

The displaying module (410) may cause the processor circuitry to perform: obtaining current geographic location information; and selecting the to-be-displayed function object from the plurality of function objects supported by the current application according to the preset presentation algorithm and the geographic location information.

The displaying module (410) may cause the processor circuitry to further perform: selecting a preset number of function objects with the highest usage from the function objects supported by the current application as to-be-displayed function objects; and displaying presentation information of the selected function objects in the function information page according to a usage order.

Preferably, the displaying module (410) may cause the processor circuitry to further perform: opening a function information page which is set up by the current application, displaying presentation information of the plurality of function objects in the function information page, and displaying the at least one page link button corresponding to each of the plurality of function objects.

The data processing page may include: a data processing page in the current application, a webpage data processing page or a data processing page in a third party application.

Preferably, the resource transfer instruction includes a value transfer instruction; and the resource library account includes a value account.

### Embodiment 5

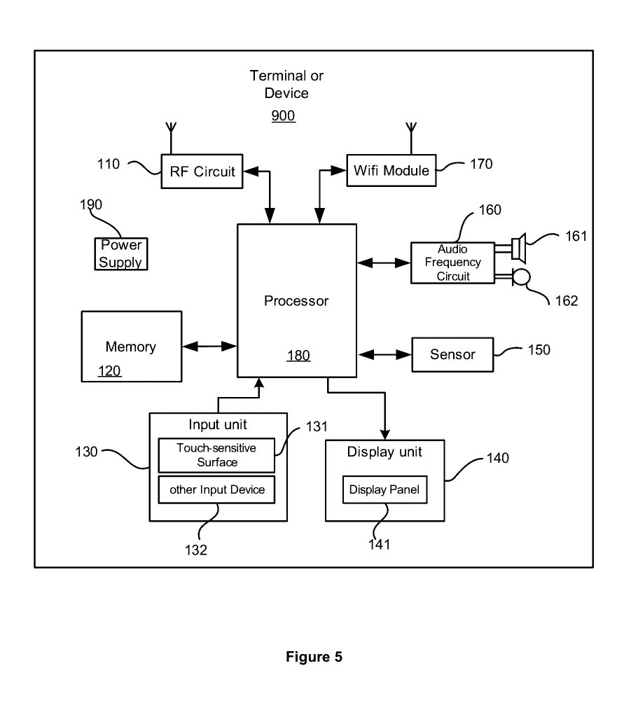

FIG. 5 is an exemplary schematic structural diagram of a terminal (900) for opening a data processing page, according to an embodiment of the present disclosure. Referring to FIG. 5, the terminal (900) may include components such as an RF (Radio Frequency) circuit (110), a memory (120) including one or more computer readable storage mediums, an input unit (130), a displaying unit (140), a sensor (150), an audio circuit (160), a WiFi (wireless fidelity) module (170), a processor (180) including one or more processing cores, and a power supply (190).

A person of ordinary skill in the art may recognize that the schematic of the terminal (900) depicts an exemplary structure without fine details which should not be interpreted as a limiting construction as shown in FIG. 5. The terminal (900) may include more or less components than shown in the drawing.

The RF circuit (110) may cause the processor circuitry to perform receiving/transmitting information or receiving and sending a signal in a call process, and in particular, receiving downlink information of a base station, and then delivering the downlink information to one or more processors (180) for processing, and sending the involved uplink data to the base station. Generally, the RF circuit (110) may include but is not limited to an antenna, at least one amplifier, a tuner, one or more oscillators, a subscriber identity module (SIM) card, a transceiver, a coupler, an LNA (Low Noise Amplifier), a duplexer and so on. Moreover, the RF circuit (110) may further communicate with a network and another device through wireless communication. The wireless communication may use any communication standard or protocol, which includes but is not limited to GSM (Global System of Mobile communication), GPRS (General Packet Radio Service), CDMA (Code Division Multiple Access), WCDMA (Wideband Code Division Multiple Access), LTE (Long Term Evolution), Email, SMS (Short Messaging Service) and so on.

The memory (120) may cause the processor circuitry to perform storing a software program and a module, and the processor 180 executes various function applications and data processing by running the software program and the module which are stored in the memory (120). The memory (120) may mainly include a program storage area and a data storage area, where the program storage area may store an operating system, and at least one application required for a function (such as a voice play function, or an image play function); and the data storage area may store data created according to the use of the terminal (900) (such as audio data or a telephone book). Moreover, the memory 120 may include a high-speed random access memory, and may further include a non-volatile memory, such as at least one magnetic disk storage device, a flash memory device, or another volatile solid storage device. Correspondingly, the memory (120) may further include a memory controller, so as to provide access of the processor (180) and the input unit (130) to the memory (120).

The input unit (130) may cause the processor circuitry to perform receiving input digital or character information, and generating a keyboard, mouse, operating rod, optical or trackball signal input relevant to user setting and function control. Specifically, the input unit 130 may include a touch sensitive surface (131) and another input device (132). The touch sensitive surface (131) is also referred to as a touch display screen or touch pad, and may collect a touch operation of a user on or close to the touch sensitive surface (131) (such as an operation performed by the user on the touch sensitive surface (131) or close to the touch sensitive surface (131) by use of a finger or any suitable object or accessory such as a touch pen), and drive a corresponding connection apparatus according to a preset program.

Optionally, the touch sensitive surface (131) may include two parts: a touch detecting apparatus and a touch controller. The touch detecting apparatus detects a touch direction of the user, detects a signal brought about by a touch operation, and transfers the signal to the touch controller. The touch controller receives touch information from the touch detecting apparatus, converts the touch information into a touch point coordinate, and then sends the touch point coordinate to the processor 180; and can receive a command sent by the processor (180) and execute the command. Moreover, the touch sensitive surface (131) may be implemented in multiple types such as resistance, capacitance, infrared and surface acoustic wave. Besides the touch sensitive surface (131), the input unit (130) may further include another input device (132). Specifically, the another input device (132) may include but is not limited to one or more of a physical keyboard, a function key (such as a volume control key, or a switching key), a trackball, a mouse, and an operating rod.

The displaying unit (140) may cause the processor circuitry (180) to perform displaying information input by the user or information provided to the user and various graphical user interfaces of the terminal, and these graphical user interfaces may be formed by a graph, a text, an icon, a video and any combination thereof The displaying unit (140) may include a displaying panel (141), and optionally, the displaying panel (141) may be configured in a form such as LCD (Liquid Crystal Display) or OLED (Organic Light-Emitting Diode). Further, the touch sensitive surface 131 may cover the displaying panel (141). After the touch sensitive surface (131) detects a touch operation on or close to the touch sensitive surface (131), the touch sensitive surface (131) transfers the touch operation to the processor 180 to determine the type of the touch event, and subsequently the processor 180 provides a corresponding visual output on the displaying panel (141) according to the type of the touch event. Although in FIG. 5, the touch sensitive surface (131) and the displaying panel (141) are used as two independent components to implement input and input functions, in some embodiments, the touch sensitive surface (131) and the displaying panel (141) may be integrated to implement the input and output functions.

The terminal (900) may further include at least one sensor (150), such as an optical sensor, a motion sensor and another sensor. Specifically, the optical sensor may include an ambient light sensor and a proximity sensor, where the ambient light sensor may adjust the luminance of the displaying panel (141) according to the brightness of the ambient light, and the proximity sensor may close and/or backlight the displaying panel (141) when the terminal 900 moves to a place close to the ear. As one type of motion sensor, a gravity acceleration sensor may detect the magnitude of an acceleration in each direction (generally a triaxial direction), may detect the magnitude and the direction of the gravity in motionlessness, and may cause the processor circuitry to perform identifying a mobile phone gesture application (such as portrait and landscape switching, relevant game, or magnetometer gesture calibration), identifying a relevant function (such as pedometer or tapping) in vibration and so on; as for other sensors such as a gyroscope, a barometer, a hygrometer, a thermometer, and an infrared sensor with which the terminal 900 may be further configured, detailed description is not made again herein.

The audio circuit (160), a loudspeaker (161), and a microphone (162) may provide an audio interface between the user and the terminal (900). The audio circuit (160) may convert the received audio data into an electrical signal, and transmit the electrical signal to the loudspeaker (161), and the loudspeaker (161) converts the electrical signal into a voice signal to be output. In another aspect, the microphone 162 converts the collected voice signal into an electrical signal, the audio circuit (160) receives the electrical signal, then converts the electrical signal into audio data, and then outputs the audio data to the processor (180) for processing, and then the processor (180) sends the processed audio data to, for example, another terminal through the RF circuit 110, or the processor 180 outputs the audio data to the memory (120) so as to perform further processing. The audio circuit 160 may further include a headphone jack, so as to provide communication between a peripheral headphone and the terminal (900).

WiFi belongs to a short-distance wireless transmission technology, the terminal 900 may help the user receive/send an electronic mail, browse a webpage and access a stream medium by using the WiFi module (170), and the WiFi module (170) provides the user with wireless broadband Internet access. Although FIG. 5 shows the WiFi module (170), but it can be understood that, the WiFi module (170) is not a necessary component of the terminal (900), and may be completely omitted according to a need without changing the essence of the present disclosure.

The processor (180) is the control center of the terminal (900), is connected to each part of the entire mobile phone by use of various interfaces and lines, executes various functions of the terminal (900) and processes data by running or executing the software program and/or module stored in the memory (120) and invoking the data stored in the memory (120), thereby wholly monitoring the mobile phone. Optionally, the processor 180 may include one or more processing cores; preferably, the processor (180) may be integrated with an application processor and a modulation/demodulation processor, where the application processor mainly processes the operating system, the user interface and applications, and the modulation/demodulation processor mainly processes wireless communication. It can be understood that, the foregoing modulation/demodulation processor may not be integrated into the processor (180).

The terminal 900 further includes the power supply (190) (such as a battery) for supplying power to each component. Preferably, the power supply may be logically connected to the processor 180 by using a power supply management system, thereby implementing functions such as charging management, discharging management, and power consumption management by using the power supply management system. The power supply (190) may further include one or more random component such as a direct-current or alternating-current power supply, a recharging system, a power supply fault detecting circuit, a power supply converter or inverter, and a power supply state indicator.

Although not shown, the terminal (900) may further include a camera, a Bluetooth module and so on, which are not described anymore herein. Specifically, in this embodiment, the displaying unit of the terminal (900) is a touch screen display, and the terminal (900) further includes a memory, and one or more non-transitory computer-readable storage medium programs, where the one or more programs are stored in the memory, and are configured to be executed by one or more processors.

The one or more programs include codes and instructions which causes the processor circuitry (180) to perform the following operations: opening a function information page which is set up by a current application, displaying presentation information of a plurality of a plurality of function objects in the function information page, and displaying at least one page link button corresponding to at least one of the plurality of function objects; when a click instruction corresponding to a target page link button in the page link button is received, opening a data processing page of a function object corresponding to the target page link button; and when a resource transfer instruction corresponding to the function object is received, performing processing of account binding on an account of the current application and a resource library account.

Preferably, the displaying presentation information of a plurality of function objects in the function information page includes: selecting a to-be-displayed function object from the plurality of a plurality of function objects supported by the current application according to a preset presentation algorithm; and displaying presentation information of the selected function objects in the function information page.

Preferably, the selecting of the to-be-displayed function object from the plurality of function objects supported by a current application according to a preset presentation algorithm includes: obtaining current geographic location information; and selecting the to-be-displayed function object from the plurality of function objects supported by the current application according to the preset presentation algorithm and the geographic location information.

Preferably, the selecting of the to-be-displayed function object from the plurality of function objects supported by a current application according to a preset presentation algorithm includes: selecting a preset number of a plurality of function objects with the highest usage from the function objects supported by the current application as to-be-displayed function objects; and the displaying of the presentation information of the selected function objects in the function information page, include: displaying the presentation information of the selected function objects in the function information page according to a usage order.

Preferably, the opening a function information page which is set up by a current application, displaying presentation information of a plurality of function objects in the function information page, and displaying at least one page link button corresponding to at least one of the function objects includes: opening the function information page which is set up by the current application, displaying the presentation information of the plurality of a plurality of function objects in the function information page, and displaying the at least one page link button corresponding to each of the plurality of function objects.

Preferably, the data processing page includes: a data processing page in a current application, a webpage data processing page or a data processing page in a third party application.

Preferably, the resource transfer instruction includes a value transfer instruction; and the resource library account includes a value account.

In the various embodiments of the present disclosure, when a function information page is opened, presentation information of a plurality of function objects is displayed in the function information page, and a page link button corresponding to at least one of the function objects is displayed; when a click instruction corresponding to a target page link button in the page link button is received, a data processing page of a function object corresponding to the target page link button is opened. That way, a user may directly skip to the data processing page by clicking a target page link button to obtain information in the data processing page to perform a subsequent resource transfer, thus skipping the step of returning to the binding process and then re-entering the data processing page, thereby improving the efficiency of completing a resource transfer.

The sequence numbers of the above-mentioned embodiments may be intended only for description, instead of indicating the relative merits of the embodiments. It should be understood by those with ordinary skill in the art which all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory. The computer-executable commands may be which is which is enabled to enable a computer, server, a smart phone, a tablet or any similar computing device to render opening data processing page operations.

The foregoing represents only some preferred embodiments of the present disclosure and their disclosure may not be construed to limit the present disclosure in any way. Those of ordinary skill in the art will recognize which equivalent embodiments may be created via slight alterations and modifications using the technical content disclosed above without departing from the scope of the technical solution of the present disclosure, and such summary alterations, equivalent has changed and modifications of the foregoing embodiments may be to be viewed as being within the scope of the technical solution of the present disclosure.

1. A method for opening a data processing page, the method comprising:
opening a function information page which is set up by a current application, displaying presentation information of a plurality of function objects in the function information page, and displaying at least one page link button corresponding to at least one of the plurality of function objects;
when a click instruction corresponding to a target page link button in the page link button is received, opening a data processing page of a function object corresponding to the target page link button; and
when a resource transfer instruction corresponding to the function object is received, performing processing of account binding on an account of the current application and a resource library account.

2. The method according to claim 1, wherein the displaying of the presentation information of the plurality of function objects in the function information page, comprising:
selecting a to-be-displayed function object from the plurality of function objects supported by the current application according to a preset presentation algorithm; and
displaying presentation information of the selected function objects in the function information page.

3. The method according to claim 2, wherein the selecting of the to-be-displayed function object from the plurality of function objects supported by the current application according to the preset presentation algorithm, comprising:
obtaining current geographic location information; and
selecting the to-be-displayed function object from the plurality of function objects supported by the current application according to the preset presentation algorithm and the geographic location information.

4. The method according to claim 2, wherein the selecting of the to-be-displayed function object from the plurality of function objects supported by a current application according to a preset presentation algorithm comprises:
selecting a preset number of function objects with the highest usage from the function objects supported by the current application as to-be-displayed function objects; and
the displaying of the presentation information of the selected function objects in the function information page, comprising:
displaying the presentation information of the selected function objects in the function information page according to a usage order.

5. The method according to claim 1, wherein the opening of the function information page which is set up by a current application, displaying presentation information of the plurality of function objects in the function information page, and the displaying the at least one page link button corresponding to the at least one of the function objects, comprising:
opening the function information page which is set up by the current application,
displaying the presentation information of the plurality of function objects in the function information page, and displaying the at least one page link button corresponding to each of the plurality of function objects.

6. The method according to claim 1, wherein the data processing page comprises: a data processing page in the current application, a webpage data processing page or a data processing page in a third party application.

7. The method according to claim 1, wherein the resource transfer instruction comprises a value transfer instruction; and the resource library account comprises a value account.

8. An apparatus for opening a data processing page, wherein the apparatus comprises at least a processor with circuitry operating in conjunction with a memory storing codes to be executed as a plurality of modules, wherein the plurality of modules comprises:
a displaying module, which causes the processor circuitry to perform:
opening a function information page which is set up by a current application,
displaying presentation information of a plurality of function objects in the function information page, and displaying at least one page link button corresponding to at least one of the plurality of function objects;
an opening module, which causes the processor circuitry to perform, when a click instruction corresponding to a target page link button in the page link button is received, opening a data processing page of a function object corresponding to the target page link button; and
a binding module, which causes the processor circuitry to perform, when a resource transfer instruction corresponding to the function object is received, performing processing of account binding on an account of the current application and a resource library account.

9. The apparatus according to claim 8, wherein the displaying module causes the processor circuitry to perform:
selecting a to-be-displayed function object from the plurality of function objects supported by the current application according to a preset presentation algorithm; and
displaying presentation information of the selected function objects in the function information page.

10. The apparatus according to claim 9, wherein the displaying module causes the processor circuitry to perform:
obtaining current geographic location information; and
selecting the to-be-displayed function object from the plurality of function objects supported by the current application according to the preset presentation algorithm and the geographic location information.

11. The apparatus according to claim 9, wherein the displaying module causes the processor circuitry to perform:
selecting a preset number of function objects with the highest usage from the function objects supported by the current application as to-be-displayed function objects; and
displaying presentation information of the selected function objects in the function information page according to a usage order.

12. The apparatus according to claim 8, wherein the displaying module causes the processor circuitry to perform:
opening a function information page which is set up by the current application,
displaying presentation information of the plurality of function objects in the function information page, and
displaying the at least one page link button corresponding to each of the plurality of function objects.

13. The apparatus according to claim 8, wherein the data processing page comprises: a data processing page in the current application, a webpage data processing page or a data processing page in a third party application.

14. The apparatus according to claim 8, wherein the resource transfer instruction comprises a value transfer instruction; and the resource library account comprises a value account.

15. A non-transitory computer-readable storage medium, wherein the computer readable storage medium stores a program which comprises codes or instructions to cause a processor circuitry to execute operations for opening a data processing page, the operations comprising:
opening a function information page which is set up by a current application, displaying presentation information of a plurality of function objects in the function information page, and displaying at least one page link button corresponding to at least one of the plurality of function objects;
when a click instruction corresponding to a target page link button in the page link button is received, opening a data processing page of a function object corresponding to the target page link button; and
when a resource transfer instruction corresponding to the function object is received, performing processing of account binding on an account of the current application and a resource library account.

16. The non-transitory computer-readable storage medium according to claim 15, wherein the displaying of the presentation information of the plurality of function objects in the function information page, comprising:
selecting a to-be-displayed function object from the plurality of function objects supported by the current application according to a preset presentation algorithm; and
displaying presentation information of the selected function objects in the function information page.

17. The non-transitory computer-readable storage medium according to claim 16, wherein the selecting of the to-be-displayed function object from the plurality of function objects supported by the current application according to the preset presentation algorithm, comprising:
obtaining current geographic location information; and
selecting the to-be-displayed function object from the plurality of function objects supported by the current application according to the preset presentation algorithm and the geographic location information.

18. The non-transitory computer-readable storage medium according to claim 16, wherein the selecting of the to-be-displayed function object from the plurality of function objects supported by a current application according to a preset presentation algorithm comprises:
selecting a preset number of function objects with the highest usage from the function objects supported by the current application as to-be-displayed function objects; and
the displaying of the presentation information of the selected function objects in the function information page, comprising:
displaying the presentation information of the selected function objects in the function information page according to a usage order.

19. The non-transitory computer-readable storage medium according to claim 15, wherein the opening of the function information page which is set up by a current application, displaying presentation information of the plurality of function objects in the function information page, and the displaying the at least one page link button corresponding to the at least one of the function objects, comprising:
opening the function information page which is set up by the current application,
displaying the presentation information of the plurality of function objects in the function information page, and displaying the at least one page link button corresponding to each of the plurality of function objects.

20. The non-transitory computer-readable storage medium according to claim 15, wherein the data processing page comprises: a data processing page in the current application, a webpage data processing page or a data processing page in a third party application.
